(19) United States
(12) Patent Application Publication
(10) Pub. No.: US 2024/0334334 A1
(43) Pub. Date: Oct. 3, 2024

(54) POWER SAVINGS TECHNIQUES

(71) Applicant: ZTE Corporation, Shenzhen (CN)

(72) Inventors: Qiujin GUO, Shenzhen (CN); Mengzhu CHEN, Shenzhen (CN); Bo DAI, Shenzhen (CN); Jun XU, Shenzhen (CN); Xuan MA, Shenzhen (CN); Xiaoying MA, Shenzhen (CN); Hong TANG, Shenzhen (CN); Ping WEI, Shenzhen (CN)

(73) Assignee: ZTE Corporation, Shenzhen (CN)

(21) Appl. No.: 18/737,671

(22) Filed: Jun. 7, 2024

Related U.S. Application Data
(63) Continuation of application No. PCT/CN2022/089114, filed on Apr. 25, 2022.

(51) Int. Cl. H04W 52/02

(52) U.S. Cl. CPC H04W 52/0235

(57) ABSTRACT

Techniques are described for power savings in wireless communication. A wireless communication method includes receiving, by a communication device, an indication information; and receiving, by the communication device, a first signal in at least one resource based on the indication information.

### CROSS-REFERENCE TO RELATED APPLICATIONS

This application is a continuation of International Patent Application No. PCT/CN2022/089114, filed on Apr. 25, 2022, the contents of which are incorporated herein by reference in their entirety.

### TECHNICAL FIELD

This disclosure is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

Techniques are disclosed for design and characteristics of a first signal that can enable power savings in some embodiments.

A wireless communication method includes receiving, by a communication device, an indication information; and receiving, by the communication device, a first signal in at least one resource based on the indication information.

In some embodiments, the indication information includes a first resource configuration for the first signal. In some embodiments, a first resource configuration for the first signal includes any one or more of the following: one or more sparser or denser transmission occasions of the first signal; or a transmission occasion configuration associated with parameters that include: a number of the first signals during a duration or a period, an offset, the duration, and/or a time gap or a specific window for the first signal. In some embodiments, the first signal is not received during the time gap, and a length of the time gap is associated with: a time length of a discontinuous transmission (DTX) inactive time, a duration of a carrier that is deactivated, a duration of a cell in an off state, a duration of a secondary cell (SCell) in a dormant state. In some embodiments, the indication information includes a second resource configuration to receive the first signal.

In some embodiments, the second resource configuration for the first signal includes a measurement window or a timer. In some embodiments, the measurement window is one of a set of candidate measurement window that is configured by a downlink control information (DCI) signaling or a medium access control-control element (MAC CE) signaling received by the communication device, and the measurement window configuration includes any one or more of the followings: a time length of the measurement window, information related to one or more transmission occasions, or one or more start positions of the one or more transmission occasions in the measurement window, a beam direction or a quasi co-location (QCL) relations of the first signal. In some embodiments, the communication device starts running the timer at a first symbol or a slot associated with a cell state transition. In some embodiments, the indication is triggered by an event, and wherein the event is associated with a cell state transition.

In some embodiments, the cell state transition includes transitioning from or to a state, the state is from a plurality of states that include an activated state, a deactivated state, a dormant state, a state performing DTX, a power saving state, or a low power sate. In some embodiments, the communication device performs any one or more of the following in response to the cell state transition to the dormant state: determining not to transmit a sounding reference signal (SRS); determining not to transmit on a physical uplink shared channel (PUSCH); or determining not to transmit or receive on a random access channel (RACH); or determining not to monitor a physical downlink control channel (PDCCH); or determining not to receive on a physical downlink shared channel (PDSCH); or determining not to transmit on a physical uplink control channel (PUCCH); or reporting channel quality indicator (CQI), a precoding matrix indicator (PMI), a rank indicator (RI), a procedure transaction identity (PTI), a channel state information reference signal resource indicator (CRI) for a cell or a PCell or a SCell; or receiving on a PDCCH or a PDSCH only, or perform CSI-RS transmission only; or transmitting on a PUCCH or a PUSCH only, or perform SRS transmission only; or operating in a downlink component carrier (DL CC) only in the cell; or operating in an uplink component carrier (UL CC) in the cell; or performing the same behaviors with a communication device in the cell with off state.

In some embodiments, a start position of the period, the time gap, the specific window or measurement window are associated with a start of a discontinuous transmission (DTX) inactive time, associated with a start position or the end position of DTX, or the symbol or slot or subframe or frame which is configured for multi-cast and broadcast single frequency network (MBSFN), or the position of a cell state transition; or the start position of the period, the time gap, the specific window or measurement window are before or after or associated with a number of consecutive symbols or slots or subframes or frames which PDCCH, PDSCH or CSI-RS are not transmitted, or PUCCH, PUSCH or SRS are not received. In some embodiments, the cell state transition includes a start of a carrier switching to a deactivation state, a start of the cell turning off, a start of the cell switching into dormant state, or a start of a carrier switching to activation state, a start of the cell turning on, a start of the cell switching into a state which is not a dormant state.

In some embodiments, a value of a period or a measurement window includes at least one of the values α*2n, wherein α is an integer which is not larger than 125, wherein n is not smaller than 0 and not larger than 10. In some embodiments, the value of a period or a measurement window is not larger than 1024 ms. In some embodiments, a length of the specific window or a measurement window is not larger than 1 ms or a half frame. In some embodiments, the indication information includes a sparser system information block (SIB) transmission or a denser SIB transmission; or a SIB type; or a modification period for an updated system information (SI) message; or a group of SIB transmission. In some embodiments, the indication information is a resource set among a list of candidate resource sets for the first signal.

In some embodiments, the indication information is included in a downlink control information (DCI) or a medium access control-control element (MAC CE) or a radio resource control (RRC) signaling received by the communication device. In some embodiments, the method further includes sending, by the communication device, a request for the first signal. In some embodiments, the request is sent in response to any one or more of the following events being met: receiving a MAC CE or a DCI which indicates a first signal based measurement; out of sync; or beam failure recovery; or random access failure; or carrier aggregation (CA) reconfiguration; or re-configuring a group of SCells; or a cell state transition. In some embodiments, wherein the request includes assistance information, a feature of the communication device associated with the first signal, or any one or more of the following information: one or more sparser or denser transmission occasions of the first signal; or a transmission occasion configuration associated with parameters that include: a number of the first signals during a duration or a period, an offset, the duration, and/or a time gap or a specific window for the first signal; a second resource configuration for the first signal including a measurement window or a timer; or a sparser system information block (SIB) transmission or a denser SIB transmission; or a SIB type; or a modification period for an updated system information (SI) message; or a group of SIB transmission. In some embodiments, the first signal includes at least one of the followings: a SSB; or a PSS; or a SSS; or a TRS; or a CSI-RS; or a PDSCH carrying SIB; or CORESET0.

In some embodiments, a next action is performed by the communication device after a time delay after the receiving the indication information. In some embodiments, the next action includes the receiving the first signal, or performing a measurement related to the first signal, or reporting an information related to the measurement related to the first signal. In some embodiments, the reporting is triggered by an event, wherein the event is associated with a cell state transition, a hybrid automatic request-acknowledgement (HARQ-ACK) feedback information, a beam failure recovery, or a asynchronization. In some embodiments, the indication information for the first signal is applicable to a secondary cell (SCell), or a primary cell (PCell), or both the SCell and the PCell. In some embodiments, in response to at least a part of the at least one resource of the first signal being overlapped with PDCCH or PDSCH, the communication device determines not to transmit in an overlapped region where the at least one resource of the first signal is overlapped with the PDCCH or the PDSCH.

In some embodiments, the PDCCH is scrambled by C-RNTI, or CS-RNTI, or MCS-C-RNTI; or the PDSCH is scheduled by a PDCCH scrambled by C-RNTI, or CS-RNTI, or MCS-C-RNTI. In some embodiments, the first signal is received in a measurement window, and wherein the measurement window only includes the first signal.

Another wireless communication method includes transmitting, by a network device, an indication information to a communication device; and transmitting, by the network device to the communication device, a first signal in at least one resource based on the indication information.

In some embodiments, the indication information includes a first resource configuration for the first signal. In some embodiments, a first resource configuration for the first signal includes any one or more of the following: one or more sparser or denser transmission occasions of the first signal; or a transmission occasion configuration associated with parameters that include: a number of the first signals during a duration or a period, an offset, the duration, and/or a time gap or a specific window for the first signal. In some embodiments, the first signal is not transmitted during the time gap, and a length of the time gap is associated with: a time length of a discontinuous transmission (DTX) inactive time, a duration of a carrier that is deactivated, a duration of a cell in an off state, a duration of a secondary cell (SCell) in a dormant state.

In some embodiments, the indication information includes a second resource configuration for the communication device to receive the first signal. In some embodiments, the second resource configuration for the first signal includes a measurement window or a timer. In some embodiments, the measurement window is one of a set of candidate measurement window that is configured by a downlink control information (DCI) signaling or a medium access control-control element (MAC CE) signaling transmitted by the network device, and the measurement window configuration includes any one or more of the followings: a time length of the measurement window, information related to one or more transmission occasions, or one or more start positions of the one or more transmission occasions in the measurement window, a beam direction or a quasi co-location (QCL) relations of the first signal. In some embodiments, the indication is triggered by an event, and wherein the event is associated with a cell state transition. In some embodiments, the cell state transition includes transitioning from or to a state, the state is from a plurality of states that include an activated state, a deactivated state, a dormant state, a state performing DTX, a power saving state, or a low power sate. In some embodiments, the network device performs any one or more of the following on the cell or primary cell (PCell) or the secondary cell (SCell) in response to the cell state transition to the dormant state: determining not to receive a sounding reference signal (SRS); determining not to receive on physical uplink shared channel (PUSCH); or determining not to receive or transmit on a random access channel (RACH); or determining not to transmit on a physical downlink control channel (PDCCH); or determining not to transmit on a physical downlink shared channel (PDSCH); or determining not to receive on a physical uplink control channel (PUCCH); or receiving channel quality indicator (CQI), a precoding matrix indicator (PMI), a rank indicator (RI), a procedure transaction identity (PTI), a channel state information reference signal resource indicator (CRI) for the cell or PCell or SCell; or performing transmissions on the PDCCH or the PDSCH only, or perform CSI-RS transmission only; or performing receptions on the PUCCH or the PUSCH only, or perform SRS reception only; or operating with only a downlink component carrier (DL CC) or only an uplink component carrier (UL CC); or performing the same operations with a cell in off state.

In some embodiments, the indication information includes a sparser system information block (SIB) transmission or a denser SIB transmission; or a SIB type; or a modification period for an updated system information (SI) message; or a group of SIB transmission. In some embodiments, the indication information is a resource set among a list of candidate resource sets for the first signal. In some embodiments, the indication information is included in a downlink control information (DCI) or a medium access control-control element (MAC CE) or a radio resource control (RRC) signaling transmitted by the network device.

In some embodiments, the method further comprises receiving, by the network device, a request for the first signal from the communication device. In some embodiments, the request is received in response to any one or more of the following events being met: transmitting a MAC CE or a DCI which indicates a first signal based measurement; out of sync; or beam failure recovery; or random access failure; or CA reconfiguration; or re-configuring a group of SCells; or a cell state transition. In some embodiments, the first signal includes at least one of the followings: a SSB; or a PSS; or a SSS; or a TRS; or a CSI-RS; or a PDSCH carrying SIB; or CORESET0. In some embodiments, the indication information for the first signal is transmitted in a secondary cell (SCell), or a primary cell (PCell), or both the SCell and the PCell. In some embodiments, the first signal is transmitted in a measurement window, and wherein the measurement window only includes the first signal.

In yet another exemplary aspect, the above-described methods are embodied in the form of processor-executable code and stored in a non-transitory computer-readable storage medium. The code included in the computer readable storage medium when executed by a processor, causes the processor to implement the methods described in this patent document.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIGS. 1A and 1B show a first signal transmission and measurement flow diagrams.

FIG. 2 shows an example Synchronization Signal/PBCH block (SSB).

FIG. 3 shows example transmission configuration for a periodic first signals.

FIG. 4 shows a transmission duration for an aperiodic first signal.

FIG. 5 shows an example of indication of skipping a first signal transmission occasion(s)

FIG. 6 shown an example of indication of parameters associated with a first signal transmission occasion.

FIG. 7A shows a time gap between two periods for a first signal transmission.

FIG. 7B shows a time gap between two adjacent durations for a first signal transmission.

FIG. 7C shows a time gap between two durations for a first signal transmission.

FIG. 8 shows an example for the measurement window of a first signal.

FIG. 9 shows an exemplary block diagram of a hardware platform that may be a part of a network device or a communication device.

FIG. 10 shows an example of wireless communication including a base station (BS) and user equipment (UE) based on some implementations of the disclosed technology.

FIG. 11 shows an exemplary flowchart for receiving a signal based on an indication information.

FIG. 12 shows an exemplary flowchart for transmitting a signal based on an indication information.

### DETAILED DESCRIPTION

In 5G NR, there are some always-on signals which may cost power even though these signals are transmitted with a long periodicity, e.g. the maximum periodicity of 160 milliseconds (ms), during micro-sleep TX (transmit, transmission or transmitter) in a low traffic load scenario. According to actual implementations, most of the transmission are unnecessary. Therefore, solutions for signal transmission enhancement are needed to achieve lower power consumption.

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

### I. Introduction

Switch to sleep mode or turn off some RF components when they are not needed are effective methods to reduce network power consumption. For example, if there is no UE access, the carrier can be deactivated. When the traffic load is low, the number of Tx/Rx antennas can be reduced.

However, there are some problems with this energy saving method. First, there are some common signals and necessary transmissions in NR, for example the SSB (Synchronization Signal/PBCH Block), SIB1 (System Information Block 1), paging, and PRACH (Physical Random Access Channel) reception. Therefore, the network cannot easily enter the low power consumption state, e.g., the sleep mode. Secondly, even if the devices can enter sleep states, it is a problem to wake up the devices. If semi-static configuration is used, the devices can be awakened only after sleeping for a period of time. If there is service requirement in sleeping states, it cannot meet the requirement, which will cause great delay and affect user experience.

To reduce power consumption of communication systems, the network should be able to enter the low power consumption state as long as possible. In addition, a more dynamic wake-up mechanism should be introduced to meet the flexible service requirements and minimize the impact on user experience. UEs can be involved in this procedure to achieve better results.

### II. Example Embodiment

In some embodiments, a first signal is disclosed to achieve power saving without increasing UE power and degrading UE experience.

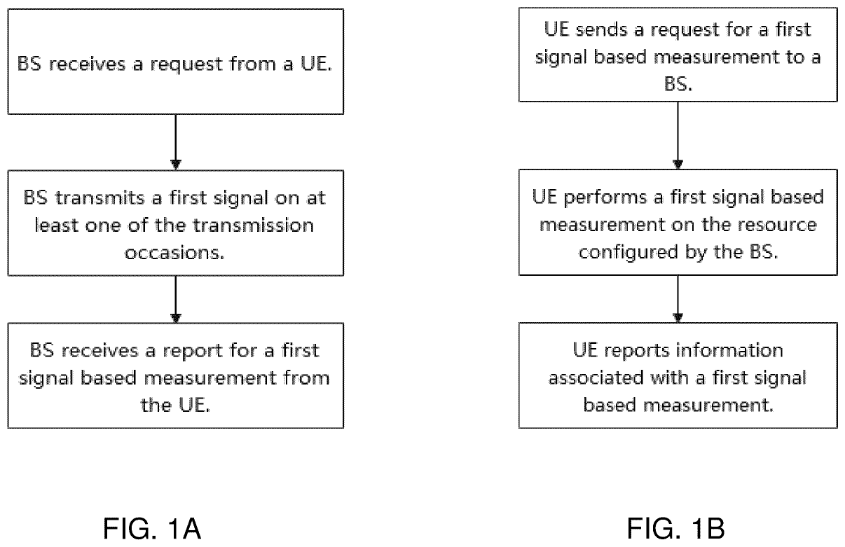

FIGS. 1A and 1B respectively show an example of a first signal transmission at BS side and a first signal based measurement at UE side. In this patent document, the transmission of a first signal at BS side consists at least one of the steps in FIG. 1A. The measurement of a first signal at UE side consists at least one of the steps in FIG. 1B.

A first signal transmission can include content of a first signal, procedure of a first signal transmission, measurement and report, restrictions on a first signal based measurement, and resource configuration for a first signal.

The design on a first signal comprises the content of a first signal, the procedure of a first signal transmission, a first signal reception, report of a first signal based measurement, and restrictions on a first signal transmission and reception, and the resource configuration of time, frequency, spatial and power domains for a first signal.

A first signal reception can include receiving the resource configuration for a first signal transmission, or receiving the first signal during the duration or in at least one of the transmission occasions, or performing the first signal based measurement, or detecting the first signal during a duration or in at least one of the transmission occasions.

A first signal is transmitted in the transmission occasion(s). Wherein the transmission occasion(s) is configured by at least one of the methods disclosed in the embodiment of II. (a)˜(h), or is related to the resource configuration for the first signal. Wherein the resource configuration includes a duration which a first signal is transmitted, a period which the duration is located in the period, an offset which determines the start position of the period or the duration, a specific window which a first signal is transmitted, a time gap which a first signal is not transmitted, or a measurement window which a first signal is received or measured by UE.

### II. (a) Content:

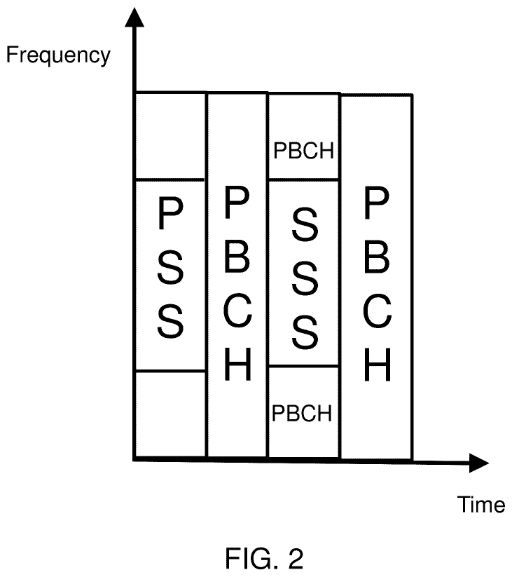

In some embodiments, a first signal comprises at least one of the following:
1. a SSB; Wherein a SSB reuses the pattern of the SSB in NR Release 17.
   a. A SSB consists of primary synchronization signal (PSS), secondary synchronization signal (SSS) and physical broadcast channel (PBCH) and occupying 4 consecutive Orthogonal Frequency Division Multiplex (OFDM) symbols and 20 resource blocks (RBs) as shown in FIG. 2
2. a PSS; Wherein a PSS has the pattern of PSS in NR Release 17.
3. a SSS; Wherein a SSS has the pattern of SSS in NR Release 17.
4. a TRS; Wherein a TRS has the pattern of TRS in NR Release 17.
   a. the TRS as a first signal should be located behind PSS, SSS or PBCH.
   b. The TRS is a RS used for secondary cell (SCell) fast activation in NR.
   c. The TRS is temporary RS in MAC layer, or tracking RS in physical layer or lower layer.
5. a CSI-RS; Wherein a channel state information reference signal (CSI-RS) has the pattern of CSI-RS in NR Release 17.
   a. the CSI-RS is a non-zero power CSI-RS, or CSI-RS for tracking, or CSI-RS for channel quality information (CQI).
   b. the resource of CSI-RS supports L1-RSRP/RSRQ (reference signal received power/reference signal received quality) report.
   c. the CSI-RS should be located behind SSB, or PSS, SSS, PBCH or TRS.
6. Control resource set (CORESET) for PDCCH scheduling PDSCH with SIB1;
7. CORESET0;
8. a PDSCH carrying SIB;
   a. a SIB includes at least one of the SIB1, posSIB, and other SIBs in 5G NR.
   b. the SIB is located behind SSB, or PSS, SSS, or PBCH of a SSB.

9. a paging early indication;

10. paging information;

11. a DMRS (de-modulation RS), wherein a DMRS has the pattern of DMRS in NR Release 17.

In some embodiments, for a first signal transmission, SSB, PSS, SSS, TRS, CSI-RS, DMRS, CORESET or SIB are configurable for a UE.

### II. (b) Procedure:

In some embodiments, a first signal based measurement for a UE can be used for one or more cell detection or discovery, cell selection, radio resource management (RRM) measurement, beam failure recovery and channel synchronization, etc.

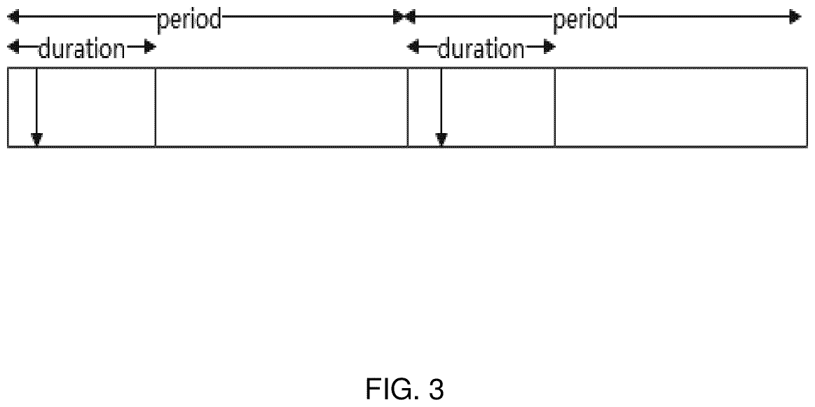

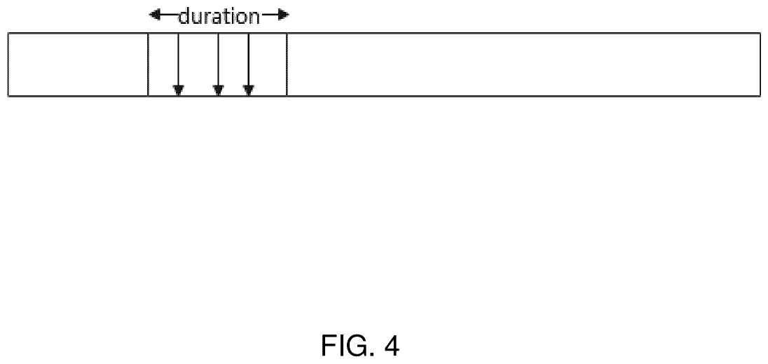

In some embodiments, two different kinds of a first signal transmission including periodic transmission of a first signal and aperiodic transmission of a first signal are shown in FIGS. 3 and 4, respectively. FIG. 3 shows that a first signal (shown with one downward arrow in each duration) is transmitted during a duration in each period. FIG. 4 shows an example of three first signals that are transmitted during a duration (shown with three downward arrows in the duration) which is triggered by an event or a signaling. Wherein the event is associated with a cell state transition. In some embodiments, the signaling is a RRC signaling, a MAC CE (medium access control control element) or a DCI (downlink control information).

In some embodiments, the duration in FIG. 4 can be a measurement window.

In some embodiments, the procedure of a first signal transmission and reception includes at least one of the followings: request for a first signal transmission, a first signal transmission in transmission occasion(s), a first signal based measurement in at least one of transmission occasion(s), report for a first signal based measurement, restrictions on a first signal based measurement.

The following example methods describe techniques to indicate configuration of a transmission occasion(s) for a first signal, and/or techniques to indicate or trigger measurement of a first signal.

In some embodiments, an indication of configuration for transmission occasion(s) for a first signal and/or an indication of measurement can be indicated by a DCI. In some embodiments, the UE can apply an application delay (also known as a time delay) that starts from when the UE receives the indication of the configuration for transmission occasion(s) of the first signal. In some embodiments, when the time delay has ended, the UE can receive or measure the first signal on the transmission occasion(s) indicated by the configuration.

In some embodiments, the application delay is associated with the SCS (subcarrier spacing) configuration of the active DL BWP (bandwidth part) on the cell, the first signal measurement configuration or the other information indicated by the same DCI.

In some embodiments, a configuration for a first signal transmission or a first signal reception based on the following methods can be applied for a cell.

In some embodiments, a configuration for a first signal transmission or a first signal reception based on the following methods is received in a first cell. In some embodiments, the configuration for a first signal transmission or a first signal reception based on the following methods which is received in a first cell is applied for a second cell. In some embodiments, the first cell is a PCell or a scheduling cell. In some embodiments, the second cell is a SCell or a scheduled cell. In some embodiments, the first cell is a PCell or a scheduled cell. In some embodiments, the second cell is a SCell or a scheduling cell.

In some embodiments, the cell is a PCell (primary cell), or a SCell, or both PCell and SCell. For example, if a UE receives an indication to measure the first signal transmitted from PCell, then the UE can measure the first signal received from the PCell, or the first signal received from the SCell, or the first signals received from both the PCell and the SCell.

In some embodiments, the SCell is a scheduled cell, or is a cell which has no scheduling data transmission. The SCell is a scheduled cell where the PCell transmits to the UE scheduling information that indicates that the UE is to receive data from the SCell.

In some embodiments, a configuration for transmission occasion(s) for a first signal or a first signal based measurement based on the following methods can be indicated by a DCI or MAC CE or RRC signaling. In some embodiments, a DCI or MAC CE or RRC (radio resource control) signaling indicate a resource for a first signal based measurement configuration among a set of candidate measurement configurations. In some embodiments, DCI or MAC CE or RRC signaling indicate an index corresponding to a first signal based measurement configuration among a set of candidate measurement configurations. In some embodiments, a set of candidate measurement configurations is configured by higher layer parameters. In some embodiments, the DCI can be DCI format 0-0/0-1/0-2, or DCI format 1-0/1-1/1-2, or DCI format 2-0/2-6/2-7, or a new DCI which is not existed in NR Rel-17.

In some embodiments, the information indicated by a DCI is related to the indication information of ‘System information indicator’ carried by DCI format 1-0 or TRS availability indication in a DCI. In some embodiments, the information includes at least one of a configuration for transmission occasion(s) for a first signal or a first signal reception or a first signal based measurement based on the following methods. In some embodiments, the CRC of DCI format 1-0 is scrambled by SI-RNTI. In some embodiments, the information is presented in a DCI when the ‘System information indicator’ is indicated as ‘0’. In some embodiments, the information is presented in a DCI when the ‘System information indicator’ is indicated as ‘1’.

In some embodiments, a list of candidate resource configurations for a first signal transmission occasion(s) or a first signal based measurement can be configured by RRC signaling for a UE.

In some embodiments, the number of the first signal which is transmitted in the duration is equal to 0 or larger than 0. In some embodiments, the number of symbols for the first signal transmission in a slot can be set or configured to 0 during a duration which a first signal is transmitted.

In some embodiments, the value of a period or a measurement window for a first signal transmission are in the unit of slot, millisecond, frame, paging cycle or DRX (discontinuous reception) cycle. In some embodiments, the value of a period or a measurement window includes at least one of the configurable values α*2ⁿ, wherein α is an integer which is not larger than 125, wherein n is not smaller than 0 and not larger than 10. In some embodiments, the value of a period or a measurement window is not larger than an integer β. Wherein β is not smaller than 160 ms and is not larger than 2048 ms. In some embodiments, the value of a period or a measurement window is not larger than 1024 ms.

In some embodiments, the length of measurement window is not larger than 1 ms or a half frame. In some embodiments, the period of the first signal measurement window is same as a periodicity for receptions of SS/PBCH blocks in the serving cell. In some embodiments, the start position of the period or measurement window are associated with the symbol or slot or half frame or frame, where the symbol, the slot, the half-frame, or the frame are configured for multi-cast and broadcast single frequency network (MBSFN), or for the cell state transition.

In some embodiments, the cell state transition includes at least one of the followings: SCell switching from activated state to deactivated state, off state or dormant state, or SCell switching from deactivated state, off state or dormant state to activated state.

In some embodiments, the cell state transition includes a cell switching from a state to a discontinuous transmission (DTX) configuration state.

In some embodiments, the start position of measurement window is before or after or associated with the number of consecutive symbols/slots/subframes/frames in which no PDCCH (physical downlink control channel), PDSCH (physical downlink shared channel) or CSI-RS are transmitted, or no PUCCH (physical uplink control channel), PUSCH (physical uplink shared channel) is received. In some embodiments, the time is a number of symbols or slots or subframes or frames.

### II. (c) Transmission Occasion(s) for a First Signal Transmission

In some embodiments, a BS transmits a first signal on the transmission occasions. In some embodiments, the parameters associated with the transmission occasion(s) of a first signal include at least one of the followings: a duration for a first signal transmission, or a period between the start positions of two durations, or an offset to determine the start position of the duration which the first signal is transmitted, or a specific window for a first signal transmission, or a time gap which a first signal does not transmitted.

In some embodiments, the transmission occasions of a first signal can be configured or determined by at least one of the following methods.

In some embodiments, request for the first signal transmission or the first signal reception or the first signal based measurement: the UE may send a request information for the first signal transmission or the first signal reception or a first signal based measurement. In some embodiments, the request information includes at least one of the followings:
1. a transmission occasion(s) of a first signal; A transmission occasion(s) of a first signal includes the values of at least one of the following:
   a. the number of first signal which is transmitted during a duration, or the number of symbols used for a first signal transmission in a slot during a duration;
   b. a duration which a first signal is transmitted;
   c. a period which is the time length between the start positions of two durations;
   d. an offset to determine the start position of a period or a duration in a period;
   e. a specific window which a first signal is transmitted;
   f. a time gap which a first signal does not transmitted;
   g. a reduced SIB transmission.
2. sparser or denser transmission occasion(s) of a first signal. For example, an indication of whether the at least one transmission occasion is sparse or dense relative to an adjacent transmission occasion;
   a. A UE can perform a sparser measurement behavior of a first signal based on a sparser transmission occasion(s), or a denser measurement behavior of a first signal based on a denser transmission occasion(s).
   b. A sparser transmission occasion(s) corresponds to a first signal based measurement configuration with a larger period, or a larger offset, or a smaller duration. A denser transmission occasion(s) corresponds to a first signal based measurement configuration with a smaller period, or a smaller offset, or a larger duration.

In some embodiments, the request information sent by UE is an assistance information. Wherein the UE assistance information is the configuration information which is preferred by UE. In some embodiments, the UE assistance information is related to the current configuration information for a first signal transmission or reception, or a list of candidate resource set for a first signal transmission or reception. Wherein the list of candidate resource set for a first signal transmission or reception includes one or more configuration for transmission occasion(s), or sparser or denser transmission occasion(s) by a higher layer parameter.

In some embodiments, the request information is associated with UE features. Wherein the UE feature is what the UE is able to do something if the UE has the UE feature. In some embodiments, the UE features include the first signal transmission or the first signal reception which is configured with a transmission occasion(s) of a first signal, or sparser or denser transmission occasion(s) by a higher layer parameter.

In some embodiments, the request information includes buffer state for UL transmission of a UE. In some embodiments, the request information includes the acknowledgement feedback for buffer state for DL transmission of a UE.

In some embodiments, the request information for a first signal based measurement can be carried by PUCCH or PUSCH.

In some embodiments, a configuration for transmission occasion(s) for a first signal: a configuration for transmission occasion(s) for a first signal are associated with at least one of the following parameters: the number of first signals during a duration or a window, period, offset, duration, a time gap or a specific window. In some embodiments, UE can detect a number of a first signals (e.g. one or more first signals) in the transmission occasion(s) according to the configuration of the duration or a measurement window. UE can perform a first signal based measurement in the transmission occasion(s).

In some embodiments, the transmission occasion(s) of a first signal are determined by the parameters of a first signal based measurement configuration. In some embodiments, the parameters of a first signal based measurement configurations are configured by RRC signaling.

In some embodiments, UE can be provided with an indication of configuration for transmission occasion(s). In some embodiments, a UE can perform a first signal based measurement, wherein the first signal is transmitted in at least one of the transmission occasion(s). In some embodiments, the configuration for transmission occasion(s) includes an indication of at least one of the followings:
1. the number of transmitted first signals during a duration or the number of symbols used for a first signal transmission in a slot during a duration, e.g. an indication for a reduced number of first signals transmission during a duration or an increased number of first signals transmission during a duration, or an indication for a single first signal transmission during a duration or multiple first signals transmission during a duration; or
2. the duration of a first signal transmission, e.g. an indication for skipping next one or a certain number of durations of a first signal transmission or an indication for starting next one or a certain number of durations of a first signal transmission, or an indication for scaling of the length of the next one or a certain number of durations of a first signal transmission, or an indication of a smaller value of duration or an indication of a larger value of duration; or
3. the period of a first signal transmission, e.g. an indication for skipping next one or a certain number of periods of a first signal transmission, or an indication for starting next one or a certain number of periods of a first signal transmission, or an indication for scaling of the length of the next one or a certain number of periods of a first signal transmission, or an indication for a larger value of period of a first signal transmission, or an indication for a larger value of period of a first signal transmission; or
4. the offset of a first signal transmission; or
5. the value of the parameters associated with a first signal transmission, i.e. the value of the duration, period or offset of a first signal transmission; or
6. a resource set of a first signal transmission. In some embodiments, there are a number of resource sets for a first signal transmission and each resource set includes a duration, a period or an offset. UE is configured with a list of candidate resource sets for a first signal transmission by higher layer parameters. Wherein a resource set among the list of candidate resource sets is indicated to a UE by MAC CE or a DCI. UE can perform a first signal based measurement according to the resource set for a first signal transmission. In some embodiments, skipping a first signal transmission during a number of durations in a same period, or skipping a first signal transmission during a number of durations in different periods; or starting a first signal transmission during a number of durations in a same period, or starting a first signal transmission during a number of durations in different periods.

In some embodiments, a larger value of period of a first signal transmission is not smaller than 160 ms. In some embodiments, a smaller value of a period of a first signal transmission is not larger than 160 ms.

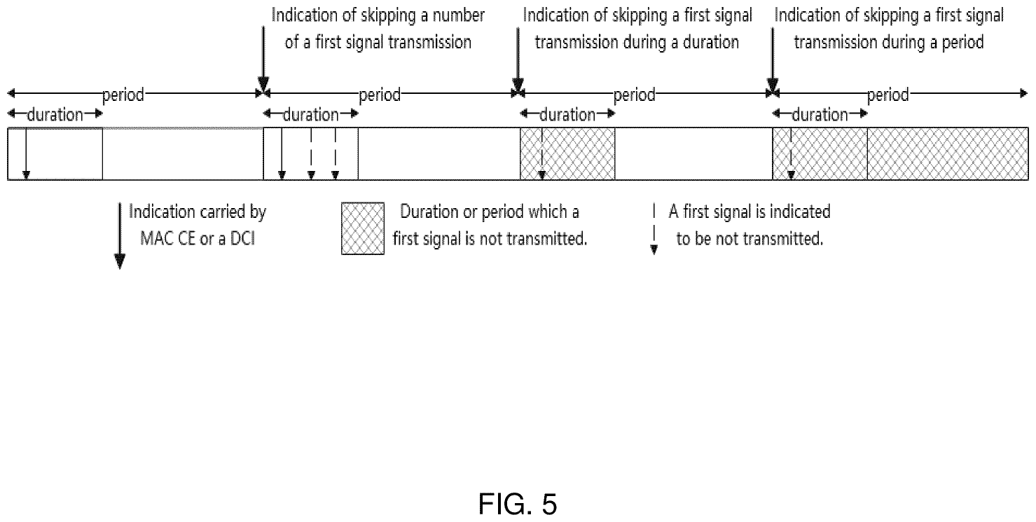

An example for the above five methods (e.g., 1 to 5) is shown in FIG. 5.

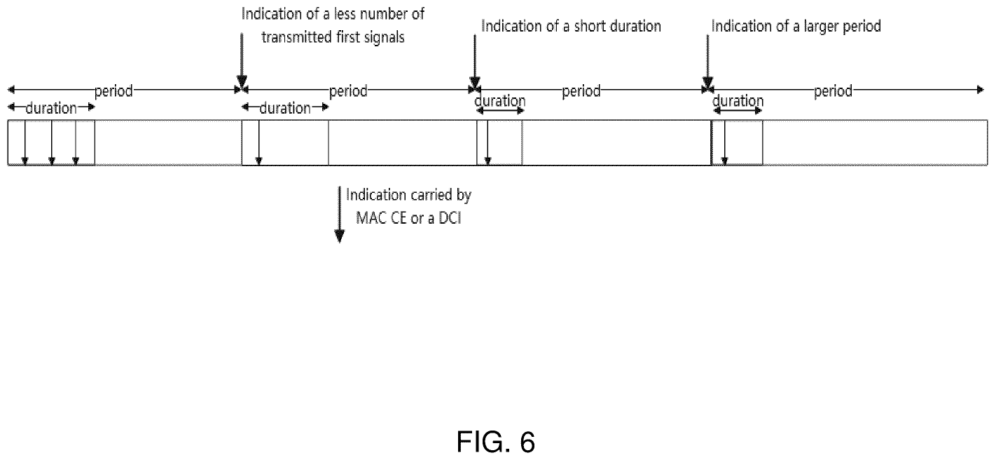

An example for the above method (e.g. 6) of indication for the value of parameters associated with a first signal transmission is shown in FIG. 6.

In some embodiments, the configuration of skipping a number of durations or periods means that the first signal can not be transmitted in the specific durations or periods, or the UE does not need to detect the first signal or perform a first signal based measurement in the skipped durations or periods. In some embodiments, the configuration of starting a number of durations or periods means that the first signal can be transmitted in the specific durations or periods, or the UE can detect the first signal or perform a first signal based measurement in the specific durations or periods. In some embodiments, the specific durations or periods stand for the next duration or period for a first signal transmission or the duration or period configured by RRC signaling or MAC CE or a DCI.

In some embodiments, a first signal transmission configuration can be applied for one duration or period, or a specific number of durations or periods, or a specific number of duration in a specific number of periods.

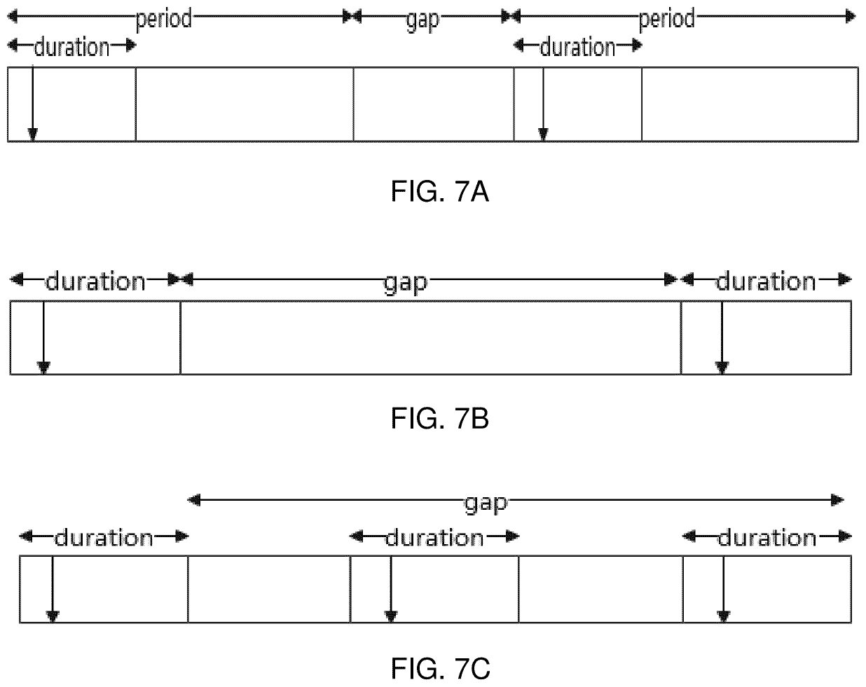

In some embodiments, a transmission off indication can be indicated for a UE. FIGS. 7A-7C show a time gap configured for a first signal transmission. In some embodiments, a time gap is configured for a first signal transmission between two periods (as shown in FIG. 7A) or a time gap between two adjacent durations (as shown in FIG. 7B) or a time gap between two durations (as shown in FIG. 7C).

In some embodiments, during the time gap, a first signal does not transmitted, or the UE does not perform a first signal based measurement. In some embodiments, the time gap can be configured by RRC signaling or a MAC CE or indicated by a DCI.

In some embodiments, the length of the time gap is associated with the time length of a DTX inactive time, the duration of a carrier keeping in deactivation, the duration of a cell in off state, the duration of a SCell keeping in dormant state, etc. In some embodiments, the start of the time gap is associated with the start of a DTX inactive time, the start of a carrier switching to deactivation state, the start of a cell turning off, the start of a SCell switching into dormant state, etc.

In some embodiments, the length of the time gap is not smaller than the 5 ms. In some embodiments, the unit of the gap can be symbol, slot, subframe, frame or millisecond. In some embodiments, the gap is only applicable for two adjacent period or a number of consecutive periods.

In some embodiments, the DTX means st least one of the followings:
1. the BS can control specific transmissions including at least one of the PDCCH or PDSCH transmission, or TRS, CSI-RS, SSB or a first signal transmission, or UL reception. In some embodiments, the PDCCH is scrambled by C-RNTI, CS-RNTI or MCS-C-RNTI, or the PDSCH is the data scheduled by the PDCCH. In some embodiments, the UL reception includes PUCCH/PUSCH transmission, or UL transmission associated with PRACH, or SRS. In some embodiments, the DTX inactive time represents the time that the specific transmissions is restricted or not configured.
2. the BS can control specific transmissions including at least one of the PDCCH or PDSCH transmission, or TRS, CSI-RS, SSB or a first signal transmission, UL reception.
3. the BS can transmit SSB, SIB, etc, in a sparse manner.

In some embodiments, the DTX inactive time represents the time that the specific transmissions is not performed by BS. In some embodiments, the DTX inactive time represents the time that the BS can transmit SSB, SIB, etc, in a sparse manner.

In some embodiment, the UEs in a cell which DTX is performed can be handovered to another band or carrier different from the cell which DTX is performed. In some embodiment, the UEs in a cell which DTX is performed can send the buffer state for UL transmission of the UEs to BS.

In some embodiments, the configuration of transmission occasion(s) can be triggered by an event. In some embodiments, wherein the configuration of transmission occasion(s) is based on above methods. In some embodiments, the event is associated with cell state transition including at least one of the followings:
1. a cell switches from an activated state to other cell state:
   a. a cell switches from an activated state to a deactivated state, or
   b. a cell switches from an activated state to a dormant state, wherein the UE behavior in a cell with dormant state is the same as that in a dormant SCell in NR, or
   c. a cell switches from an activated state to a state performing DTX, or
   d. a cell switches from an activated state to a power saving state or a low power sate.
2. a cell switches from a state to an activated state:
   a. a cell switches from a deactivated state to an activated state, or
   b. a cell switches from a dormant state to an activated state, or
   c. a cell switches from a state performing DTX to an activated state, or
   d. a cell switches from a power saving state or a low power sate to an activated state.

In some embodiments, he UE behavior in a cell with dormant state is the same as that in a dormant SCell in NR. In some embodiments, the dormant state is a cell state which is defined below the serving cell state.

In some embodiments, a SIB transmission can be configured or indicated by a DCI, a MAC CE or RRC signaling. In some embodiments, a SIB transmission includes a reduced SIB transmission, or a SIB transmission includes a sparser SIB transmission or a denser SIB transmission.

In some embodiments, a reduced SIB transmission is associated with a SIB type. In some embodiments, a certain types of SIB can not be transmitted, wherein the SIB type includes at least one of the followings: SIB1, SIB2, SIB3, SIB5, SIB7, SIB11 or SIB18 for IDLE mode UE, or SIB1, SIB2, SIB3, SIB4, SIB5, SIB6, SIB7, SIB11, SIB12 or SIB18 for RRC connected mode UE, or other SIBs including SIB13, SIB14, SIB15, SIB16, SIB17, SIB19, SIB20, etc. in NR system, or posSIBs. For example, in a serving cell, only SIB1 and SIB2 is transmitted, or SIB6, SIB7 or SIB8 are not transmitted.

In some embodiments, the reduced SIB is associated with modification period for the updated SI message. In some embodiments, SIB can not be transmitted in a certain number of period.

In some embodiments, the reduced SIB is associated with a reduced SI information contents or bits of the transmitted SIB compared with the existing SIB in NR. In some embodiments, at least one of the following contents may not be transmitted after a reduced SIB transmission indication is applied: the information associated with intra-frequency cell or carrier, the information associated with SSB, the information associated with relaxed measurement.

In some embodiments, the reduced SIB is associated with a group of SIB transmission, including at least one of the follows:
1. the SIB which can be grouped to be transmitted for a UE includes at least one of the followings: SIB1, SIB2, SIB3, SIB5, SIB7, SIB11 or SIB18 for IDLE mode UE, or SIB1, SIB2, SIB3, SIB4, SIB5, SIB6, SIB7, SIB11, SIB12 or SIB18 for RRC connected mode UE or posSIBs. For example, the group 1 includes SIB1, group 2 includes SIB1, SIB2 and SIB3.
2. a UE can be configured with a number of candidate groups of SIB.
3. the UE can be indicated with a group index by a DCI to receive the SIB(s) included in the group of SIB messages with the group index. In some embodiments, the DCI is DCI format 0-1 or DCI format 0-0.

In some embodiments, a SIB transmission changing is only applied for RRC IDLE mode UE. In some embodiments, the reduced SIB transmission or the group of SIB transmission are configured in SystemInformation IE. In some embodiments, the reduced SIB transmission can be indicated by the SI change indication.

In some embodiments, the reduced SIB transmission is configured per serving cell. In some embodiments, the reduced SIB is transmitted or applied in SCell.

In some embodiments, a UE can send a request for a reduced SIB transmission.

In some embodiments, a SIB transmission includes a sparser SIB transmission or a denser SIB transmission. In some embodiments, a UE can send a request for a sparser SIB transmission, e.g. only a SIB1 needs to be transmitted. In some embodiments, a UE can send a request for a denser SIB transmission, e.g. SIB1, SIB2, SIB3 and SIB17 need to be transmitted.

In some embodiments, for RRC connected mode UE, a SIB is transmitted in a part of serving cells. In some embodiments, for idle mode UE, a reduced SIB is transmitted in the serving cell.

In all of above embodiments, indication of configuration for transmission occasion(s), transmission off indication, event-based configuration of transmission occasion(s) or SIB transmission are required the inter-cell information interaction. In some embodiments, the cells interacting information are intra-band or inter-band. The inter-cell information includes at least one of the followings:
1. a first signal transmission configuration; or
2. DTX configuration; or
3. cell state; or
4. SSB transmission power; or
5. Slot format or MBSFN configuration; or
6. low-load period configuration; or
7. upload or download information; or
8. buffer state for DL transmission; or
9. buffer state for UL transmission of UE; or
10. handover parameters; or
11. UL or DL frequency or carrier turned off; or
12. applicable antenna port; or
13. beam information; or
14. interference over Thermal (IoT) measurement; or
15. switch-on decision threshold for a serving cell; or
16. information associated with UE measurement including position information, UE ID, best server(s) reported by UE, synchronization information, RSRP/RSRQ values, SINR values, a preferred cell state, or parameters associated with interference mitigation.

In some embodiments, the cell state includes cell state of PCell and SCell. In some embodiments, the cell state includes dormant state, activated state, deactivated state, low power consumption state, or DTX state.

### II. (d) A First Signal Reception (or a First Signal Based Measurement)

In some embodiments, a first signal reception and a first signal based measurement represent the same meaning or corresponds to the same operations.

In some embodiments, an indication that triggers a first signal reception including measurement of the first signal (also known as first signal based measurement indication) is sent by BS. In some embodiments, the UE can perform a first signal based measurement in the transmission occasion(s) of the first signal according to indication of a first signal based measurement.

In some embodiments, the information of a first signal based measurement indication is indicated based on the request for the transmission occasion(s) of a first signal.

In some embodiments, UE can be indicated a first signal based measurement indication. In some embodiments, UE may perform a first signal based measurement on the transmission occasion(s) of a first signal according to the first signal based measurement indication.

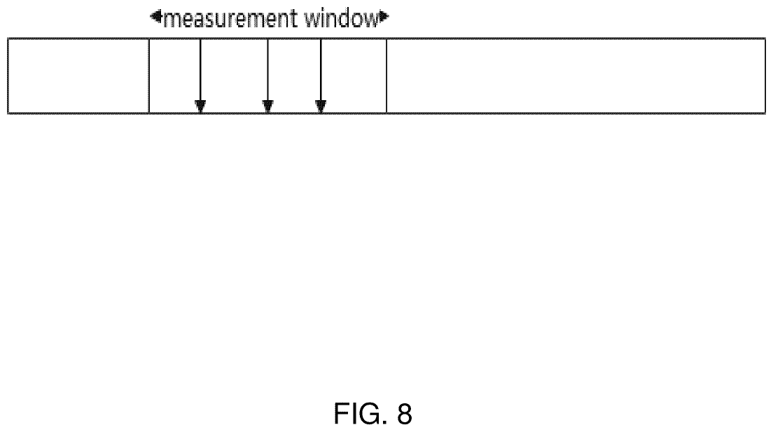

In some embodiments, measurement window is indicated for a UE to receive a first signal. In some embodiments, a first signal is transmitted in a measurement window. In some embodiments, UE assumes that only a first signal is transmitted in the measurement window. An example of a first signal transmission in a measurement window is shown in FIG. 8.

In some embodiments, the measurement window is configured by higher layer signalling or is indicated by a DCI. In some embodiments, a set of candidate measurement window configurations is configured for the UE. In some embodiments, a DCI or MAC CE can indicate one of the candidate measurement window to UE. In some embodiments, the candidate measurement window configurations include at least one of the followings: the time length of the specific window, the transmission occasion(s), the start position of a first signal transmission occasion(s) in the measurement window, the number or start position of RBs allocated for a first signal, the beam direction or the QCL relations of a first signal transmitted in the measurement window. In some embodiments, the start position or length of the measurement window is disclosed above the paragraph of ‘Transmission occasion(s)’.

In some embodiments, a timer associated with the a first signal reception or measurement can be configured for the UE. In some embodiments, during the time of the timer running, the first signal is not transmitted or the UE can not receive a first signal or perform a first signal based measurement.

In some embodiments, the value of timer is associated with the SCS configuration of the BWP on a cell or PCell or SCell, or the value of period of the first signal based measurement configuration, or the value of duration of the first signal based measurement configuration.

In some embodiments, the timer is set as the value configured by higher layer parameters at the first symbol or slot after a timer is configured or reconfigured by higher layer parameters or is expired, or a cell transitions its state to a low power state.

In some embodiments, UE starts running the timer at the first symbol or slot which a cell transitions its state to a low power state or which a timer is configured or reconfigured by RRC signaling. In some embodiments, the expiration of the timer means the timer is counting to the value configured by higher layer parameters, or is decremented to 0.

In some embodiments, UE stops running the timer after occurring at least one of the following events:
1. receiving a MAC CE or a DCI which indicates a first signal based measurement;
2. out of sync;
3. beam failure recovery;
4. random access failure;
5. CA reconfiguration;
6. re-configuring a group of SCells;
7. etc.

In some embodiments, the event of out of sync includes the event that the out-of sync times is larger than a threshold. Wherein the threshold is not smaller than 0 and is not larger than the maximum number of out-of-sync configured by RRC signaling.

In some embodiments, a first signal reception or a first signal based measurement configuration based on above methods can be triggered by an event. In some embodiments, the event is associated with cell state transition including at least one of the followings:
1. a cell switches from an activated state to other cell state:
   a. a cell switches from an activated state to a deactivated state, or
   b. a cell switches from an activated state to a dormant state, or
   c. a cell switches from an activated state to a state performing DTX, or
   d. a cell switches from an activated state to a power saving state or a low power sate.
2. a cell switches from a state to an activated state:
   a. a cell switches from a deactivated state to an activated state, or
   b. a cell switches from a dormant state to an activated state, or
   c. a cell switches from a state performing DTX to an activated state, or
   d. a cell switches from a power saving state or a low power sate to an activated state.

In some embodiments, the UE behavior in a cell with dormant state is the same as that in a dormant SCell in NR. In some embodiments, the dormant state is a cell state which is defined below the serving cell state.

### II. (e) Report

In some embodiments, UE may report a first signal based measurement after performing a first signal based measurement.

In some embodiments, report of a first signal based measurement can be triggered by an event. In some embodiments, the event is associated with a cell state transition, a HARQ-ACK (hybrid automatic request-acknowledgement) feedback information, a beam failure recovery, or a out-of-sync.

In some embodiments, the events may include at least one of the followings:
1. A UE reports the last recent first signal based measurement at the first symbol, slot or subframe after the SCell switching from deactivation/dormant/off state to activation state.
2. A UE reports the last recent first signal based measurement if the UE fed back HARQ-ACK information as a ‘NACK’.
3. A UE reports the last recent first signal based measurement if the beam failure recovery or asynchronization are occurred at the UE side.
4. In the case of SCell state transition, the last recent first signal based measurement represents that the last recent measurement of a first signal which is transmitted in PCell or SCell during the SCell in dormant/deactivation/off state. In some embodiments, the PCell and SCells are in the same band.
5. In the case of DRX configuration for a UE, if there is no first signal based measurement during the SCell in dormant/deactivation/off state, the last recent first signal based measurement during the last recent DRX active time can be used for report.
6. In the case of DTX configuration for a cell, if there is no first signal based measurement, the last recent first signal based measurement can be reported.

In some embodiments, the report can be indicated by a DCI with UL scheduling. In some embodiments, a UE can report a first signal based measurement in a PUCCH or a PUSCH.

### II. (f) Measurement Restriction

In some embodiments, restrictions on a first signal transmission or reception are related to the configuration of a first signal in time, frequency, spatial or power domain.

In some embodiments, indication of a first signal transmission or indication of a first signal reception or a first signal based measurement are only applied for a cell satisfied with at least one of the following conditions:
1. a cell is SCell, or
2. a cell is PCell, or
3. a cell which can schedule data, or
4. a cell which in the last n symbols, slot or subframe of a duration before the cell is transitioned to a deactivated state or a dormant state or a low power state or off state, or
5. a cell which in the first n symbols, slot or subframe of a duration before the cell is transitioned to a activated state or on state.

In some embodiments, n is an integer and not smaller than 4.

In some embodiments, if UE is provided with a first signal configuration and at least a part of the configured resource of a first signal is overlapped with PDCCH/PDSCH, the UE assumes that the PDCCH/PDSCH does not transmitted in the overlapped resource. In some embodiments, the PDCCH is scrambled by C-RNTI, or CS-RNTI, or MCS-C-RNTI. In some embodiments, the PDSCH is scheduled by a PDCCH scrambled by C-RNTI, or CS-RNTI, or MCS-C-RNTI.

In some embodiments, when a first signal comprises CSI-RS, the resource of CSI-RS supports L1-RSRP/RSRQ report.

In some embodiments, the maximum number of first signal per period is not larger than that of SSBs per half frame. Wherein the period is not smaller than half frame.

In some embodiments, when a first signal comprises SSB or CORESET0, the UE shall perform a first signal based measurement according to above restrictions.

### II. (g) Resource Configuration:

In some embodiments, a first signal transmission is configured for a serving cell, or the configuration of a first signal transmission is cell specific.

In some embodiments, time domain resource configuration for a first signal transmission or reception or measurement includes at least one of the followings:
1. Period and offset: the value of period can be at least one of [5, 10, 20, 40, 80, 160, 320, 640, 1280], and the offset can be one of the values in the range of 0˜(the value of period-1).
2. Duration: the value of duration can be at least one of [1, 2, 3, 4, 5].
3. Wherein the unit of period, offset and duration are subframe or millisecond.

In some embodiments, the period of the first signal transmission is same as a periodicity for receptions of SS/PBCH blocks in the serving cell.

In some embodiments, the maximum period of a first signal transmission is not larger than 1.024 second.

In some embodiments, if a first signal is transmitted in a slot or a subframe or a frame, UE can not transmit PUCCH, PUSCH or SRS in the slot or subframe or frame.

In some embodiments, a first signal can be transmitted in a slot denoted as ‘flexible’. UE can not receive PDCCH or PDSCH, or transmit PUCCH, PUSCH, RA preamble or SRS in a ‘flexible’ slot which a first signal is transmitted.

In some embodiments, a first signal can be transmitted at the first slot of the half frame, or the first symbol or slot or subframe or frame before the SCell is deactivated, or before the DL CC of a SCell is deactivated.

In some embodiments, the length of a first signal burst is larger than or equal to 1 slot for every SCS.

In some embodiments, the start position of a first signal burst is associated with the start position or the end position of discontinuous transmission (DTX), or the position of a cell state transition.

In some embodiments, frequency domain resource configuration for a first signal transmission or reception or measurement includes at least one of the following:
1. when inter-band carrier aggregation is configured for a UE, there is no restriction on transmitting PUCCH, PUSCH or SRS or receiving PDCCH, PDSCH, TRS, CSI-RS on all of the cells in the other bands.
2. the number of resource block, the start position of resource block and the bandwidth part carrying a first signal are configured by RRC signaling.
3. the number of RBs used for a first signal transmission is not larger than 20 RBs. The number of RBs can be reported by UE or can be provided by a dedicated configuration for a serving cell.
4. for intra-band carrier aggregation, a first signal can be only transmitted in PCell, or the first signal based measurement in SCell is performed in PCell, or the maximum number of a first signal transmission in PCell during a period is larger than that in SCell.
5. when intra-band carrier aggregation is configured for a UE, UE is not expected to transmit PUCCH, PUSCH or SRS or receive PDCCH, PDSCH, TRS, CSI-RS on all of the cells in the same band on the symbols or slots or subframes or frames that fully or partially overlap with the symbols which a first signal is transmitted.

In some embodiments, spatial domain resource configuration for a first signal transmission or reception or measurement includes at least one of the following:
1. the ssb-PositionQCL, SSB-PositionQCL-Relation and SSB-ToMeasure information elements (IEs) can be used to determine the spatial domain configuration for a first signal transmission.
2. UE assumes that a first signals in a serving cell are quasi co-located with respect to average gain, quasi co-location ‘typeA’ or ‘typeD’ properties if q1 mod q2 is the same among the first signals. Wherein q1 or q2 is associated with the configuration of the length of a first signal burst duration/occasion/periodicity. Wherein q1 is the sequence index of PSS, SSS or DMRS, or resource set ID of CSI-RS or TRS, or antenna port index of CSI-RS or TRS. Wherein q2 is the QCL (quasi co-location) relation between SSB positions for this serving cell.
3. the resource configuration for a first signal transmission is UE-specific or cell-specific; or
4. the SSB index for a first signal transmission is explicitly indicated by RRC signaling.

In some embodiments, the measurement timing configurations (MTC) of the first signal includes duration, periodicity and offset of the measurement window in which to receive a first signal, PCIs (physical cell identities) that are known to follow the MTC of the first signal, or the set of indexes of signals as part of a first signal, or the QCL relationship between the positions of signals (e.g. SSB, CSI-RS or TRS, etc.) on the frequency.

In some embodiments, power domain resource configuration for a first signal transmission or reception or measurement includes at least one of the following:
1. the power for a first signal transmission can be indicated by a DCI, MAC CE or RRC signaling. Wherein the power is one of the power values in the range configured by higher layer parameters.
2. the power for a first signal transmission can be reported by UE assistance information.
3. a BS accessing a channel on which transmission(s) are performed, shall set the energy detection threshold to be less than or equal to the maximum energy detection threshold. Wherein the maximum energy detection threshold for a first signal transmission is larger than that for other DL transmissions.

In some embodiments, the maximum transmission power of a first signal can be larger than the PDSCH/PDCCH transmission. In some embodiments, for idle mode UE, the PDCCH is scrambled by P-RNTI, PEI-RNTI, TC-RNTI, and other RNTIs used for idle mode UE in NR. In some embodiments, the PDSCH is scheduled by P-RNTI, PEI-RNTI, TC-RNTI, and other RNTIs. In some embodiments, for connected mode UE, the PDCCH is scrambled by C-RNTI, CS-RNTI, MCS-C-RNTI, and other RNTIs used for connected mode UE in NR. In some embodiments, the PDSCH is scheduled by C-RNTI, CS-RNTI, MCS-C-RNTI, and other RNTIs used for connected mode UE in NR.

In some embodiments, sequence domain resource configuration for a first signal transmission or reception or measurement includes at least one of the following:
1. Scrambling ID of PSS, SSS, CSI-RS or TRS included in a first signal is physical cell identity (PCID).
2. Transmission point (TP) identification may be represented by the sequence index of signals included in a first signal, the resource set index of CSI-RS or TRS, scrambling ID of signals included in a first signal, or subframe offset.

### II. (h) Serving Cell State

In this patent document, the UE behaviors or BS operations in a cell which is switched to a state are disclosed in the following.

In some embodiments, low power state of a cell includes at least one of the following states except for the normal state.

In some embodiments, DTX state or a cell with DTX configuration: a cell with DTX configuration include at least one of the followings:
1. when a cell with DTX configuration, the period of a first signal transmission may be relaxed.
2. when a cell with DTX configuration, UL transmission for UEs in the cell may be stopped. In some embodiments, the UL transmission includes PUCCH, PUSCH, SRS, or UL tranmission associated with PRACH procedure.
3. when a cell with DTX configuration, DL transmission in the cell may not be performed by BS. In some embodiments, the DL transmission includes PDCCH, PDSCH, CSI-RS, TRS, or signalings sent by BS. In some embodiments, a sparser first signal transmission is also performed by BS. In some embodiments, the measurement for the first signal can be performed by UE.
4. UE behaviors or BS operations during a cell in DTX state are associated with the time length of DTX on duration or DTX active time, or the time length of DTX inactive time.

In some embodiments, the time length of DTX on duration or DTX active time, or the time length of DTX inactive time have at least two levels including symbol level, slot level, frame level, 1/100-millisecond level, 1/10-millisecond level, millisecond level, tens of millisecond level, hundreds of millisecond level or second level. Each level of the time length corresponds to a kind of power saving state of the cell.

In some embodiments, for a cell with DTX configuration, different kinds of power saving state of a cell control different different kinds of activities.

In some embodiments, a cell has at least one of the 4 power saving states. Wherein the activity corresponding to a power saving state includes reduced symbols for DL/UL data transmission, or PDCCH/PDSCH transmission or PUCCH/PUSCH transmission, or PBCH. Wherein the activity corresponding to a power saving state includes reduced bandwidth for DL/UL data transmission, or PDCCH/PDSCH transmission or PUCCH/PUSCH transmission. Wherein the activity corresponding to a power saving state includes reduced number of antenna ports for DL/UL data transmission, or PDCCH/PDSCH transmission or PUCCH/PUSCH transmission. Wherein the activity corresponding to a power saving state includes only a first signal transmission or a second signal reception.

In some embodiments, different actions are supported by the cell corresponding to the different kinds of power saving state of a cell, or different levels of the time length. For example, the a first signal is transmitted for the cases that the time length of DTX inactive time is in a second level.

In some embodiments, a UE in the SCell with dormant state can at least:
1. not transmit SRS on the SCell; or
2. report CQI/PMI/RI/PTI/CRI for the SCell according to the periodicity indicated by cqi-ReportPeriodic-SCell-r15; or
3. not transmit on UL-SCH on the SCell; or
4. not transmit on RACH on the SCell; or
5. not monitor the PDCCH on the SCell; or
6. not monitor the PDCCH for the SCell; or
7. not transmit PUCCH on the SCell.

In some embodiments, a UE in the cell with dormant state can at least:
1. only perform PDCCH or PDSCH or CSI-RS transmission; or
2. only perform PUCCH or PUSCH or SRS transmission; or
3. only perform behaviors on a DL CC or UL CC in NR; or
4. only perform behaviors on a cell with off state.

In some embodiments, a cell in a dormant state can at least:
1. perform a first signal transmission; or
2. perform RACH procedure; or
3. not receive or response a RSRP/RSRQ report; or
4. support configuration of a reduced bandwidth; or
5. support configuration of a reduced number of antenna ports; or
6. support configuration of DTX; or
7. support performing a first signal transmission during a DTX state; or
8. not perform beam measurement.

In some embodiments, a cell can supports at least one of the following states:
1. SCell dormant state;
2. SCell deactivated
3. SCell activated
4. less or sparse SSB transmission or a first signal transmission.

In some embodiments, for inter-cell scenario, cell supports at least one of the following states:
1. less SSB transmission or sparser a first signal transmission or constrains on Msg1 or Msg3 or MsgA reception for RACH procedure;
2. low power consumption mode;
3. only PDCCH or PDSCH or CSI-RS transmission; or
4. only PUCCH or PUSCH or SRS transmission.

In some embodiments, when a BS informs UEs in a cell with DTX configuration, the UE shall report information of turning off or stopping UL transmission. In some embodiments, a BS starts performing DTX after specific UEs in the cell reports information of turning off or stopping UL transmission. In some embodiments, the specific UEs in the cell are RRC connected mode UEs or RRC idle mode UEs or RRC inactive mode UEs.

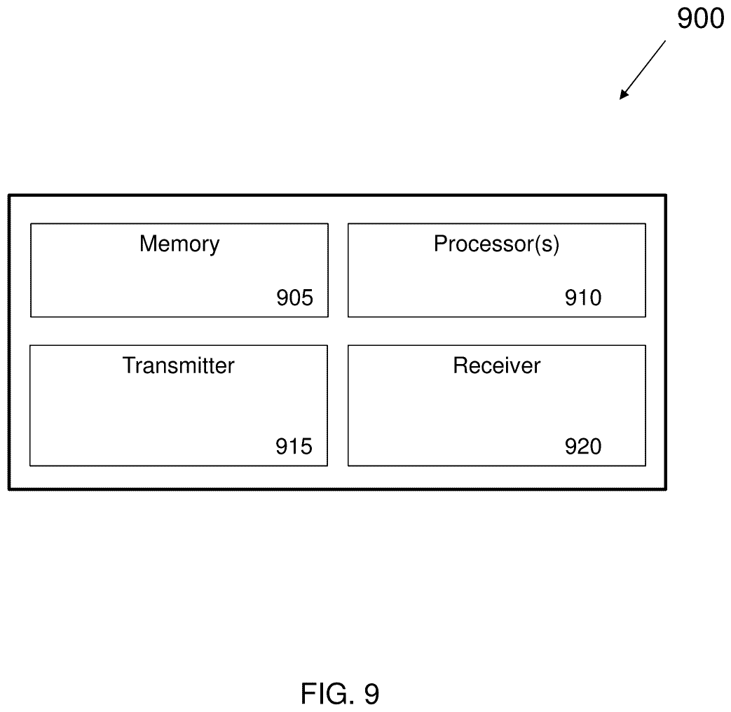

FIG. 9 shows an exemplary block diagram of a hardware platform 900 that may be a part of a network device (e.g., base station) or a communication device (e.g., a user equipment (UE)). The hardware platform 900 includes at least one processor 910 and a memory 905 having instructions stored thereupon. The instructions upon execution by the processor 910 configure the hardware platform 900 to perform the operations described in FIGS. 1 to 8 and 10 to 12 and in the various embodiments described in this patent document. The transmitter 915 transmits or sends information or data to another device. For example, a network device transmitter can send a message to a user equipment. The receiver 920 receives information or data transmitted or sent by another device. For example, a user equipment can receive a message from a network device.

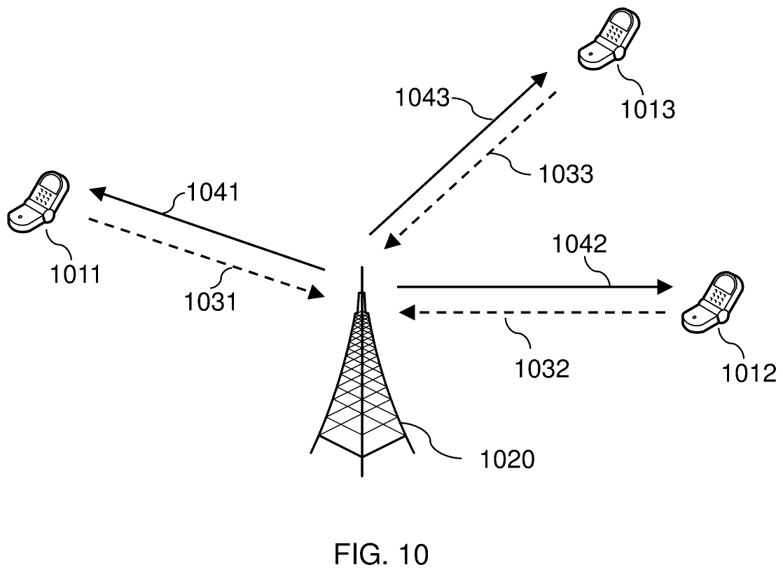

The implementations as discussed above will apply to a wireless communication. FIG. 10 shows an example of a wireless communication system (e.g., a 5G or NR cellular network) that includes a base station 1020 and one or more user equipment (UE) 1011, 1012 and 1013. In some embodiments, the UEs access the BS (e.g., the network) using a communication link to the network (sometimes called uplink direction, as depicted by dashed arrows 1031, 1032, 1033), which then enables subsequent communication (e.g., shown in the direction from the network to the UEs, sometimes called downlink direction, shown by arrows 1041, 1042, 1043) from the BS to the UEs. In some embodiments, the BS send information to the UEs (sometimes called downlink direction, as depicted by arrows 1041, 1042, 1043), which then enables subsequent communication (e.g., shown in the direction from the UEs to the BS, sometimes called uplink direction, shown by dashed arrows 1031, 1032, 1033) from the UEs to the BS. The UE may be, for example, a smartphone, a tablet, a mobile computer, a machine to machine (M2M) device, an Internet of Things (IoT) device, and so on.

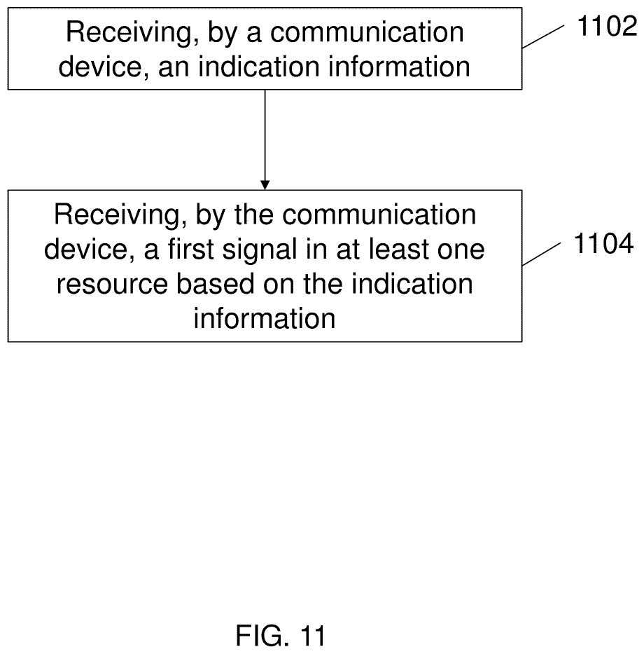

FIG. 11 shows an exemplary flowchart for receiving a signal based on an indication information. Operation 1102 includes receiving, by a communication device, an indication information. Operation 1104 includes receiving, by the communication device, a first signal in at least one resource based on the indication information.

In some embodiments, the indication information includes a first resource configuration for the first signal. In some embodiments, a first resource configuration for the first signal includes any one or more of the following: one or more sparser or denser transmission occasions of the first signal; or a transmission occasion configuration associated with parameters that include: a number of the first signals during a duration or a period, an offset, the duration, and/or a time gap or a specific window for the first signal. In some embodiments, the first signal is not received during the time gap, and a length of the time gap is associated with: a time length of a discontinuous transmission (DTX) inactive time, a duration of a carrier that is deactivated, a duration of a cell in an off state, a duration of a secondary cell (SCell) in a dormant state. In some embodiments, the indication information includes a second resource configuration to receive the first signal.

In some embodiments, the second resource configuration for the first signal includes a measurement window or a timer. In some embodiments, the measurement window is one of a set of candidate measurement window that is configured by a downlink control information (DCI) signaling or a medium access control-control element (MAC CE) signaling received by the communication device, and the measurement window configuration includes any one or more of the followings: a time length of the measurement window, information related to one or more transmission occasions, or one or more start positions of the one or more transmission occasions in the measurement window, a beam direction or a quasi co-location (QCL) relations of the first signal. In some embodiments, the communication device starts running the timer at a first symbol or a slot associated with a cell state transition. In some embodiments, the indication is triggered by an event, and wherein the event is associated with a cell state transition.

In some embodiments, the cell state transition includes transitioning from or to a state, the state is from a plurality of states that include an activated state, a deactivated state, a dormant state, a state performing DTX, a power saving state, or a low power sate. In some embodiments, the communication device performs any one or more of the following in response to the cell state transition to the dormant state: determining not to transmit a sounding reference signal (SRS); determining not to transmit on a physical uplink shared channel (PUSCH); or determining not to transmit or receive on a random access channel (RACH); or determining not to monitor a physical downlink control channel (PDCCH); or determining not to receive on a physical downlink shared channel (PDSCH); or determining not to transmit on a physical uplink control channel (PUCCH); or reporting channel quality indicator (CQI), a precoding matrix indicator (PMI), a rank indicator (RI), a procedure transaction identity (PTI), a channel state information reference signal resource indicator (CRI) for a cell or a PCell or a SCell; or receiving on a PDCCH or a PDSCH only, or perform CSI-RS transmission only; or transmitting on a PUCCH or a PUSCH only, or perform SRS transmission only; or operating in a downlink component carrier (DL CC) only in the cell; or operating in an uplink component carrier (UL CC) in the cell; or performing the same behaviors with a communication device in the cell with off state.

In some embodiments, a start position of the period, the time gap, the specific window or measurement window are associated with a start of a discontinuous transmission (DTX) inactive time, associated with a start position or the end position of DTX, or the symbol or slot or subframe or frame which is configured for multi-cast and broadcast single frequency network (MBSFN), or the position of a cell state transition; or the start position of the period, the time gap, the specific window or measurement window are before or after or associated with a number of consecutive symbols or slots or subframes or frames which PDCCH, PDSCH or CSI-RS are not transmitted, or PUCCH, PUSCH or SRS are not received. In some embodiments, the cell state transition includes a start of a carrier switching to a deactivation state, a start of the cell turning off, a start of the cell switching into dormant state, or a start of a carrier switching to activation state, a start of the cell turning on, a start of the cell switching into a state which is not a dormant state.

In some embodiments, a value of a period or a measurement window includes at least one of the values α*2n, wherein α is an integer which is not larger than 125, wherein n is not smaller than 0 and not larger than 10. In some embodiments, the value of a period or a measurement window is not larger than 1024 ms. In some embodiments, a length of the specific window or a measurement window is not larger than 1 ms or a half frame. In some embodiments, the indication information includes a sparser system information block (SIB) transmission or a denser SIB transmission; or a SIB type; or a modification period for an updated system information (SI) message; or a group of SIB transmission. In some embodiments, the indication information is a resource set among a list of candidate resource sets for the first signal.

In some embodiments, the indication information is included in a downlink control information (DCI) or a medium access control-control element (MAC CE) or a radio resource control (RRC) signaling received by the communication device. In some embodiments, the method further includes sending, by the communication device, a request for the first signal. In some embodiments, the request is sent in response to any one or more of the following events being met: receiving a MAC CE or a DCI which indicates a first signal based measurement; out of sync; or beam failure recovery; or random access failure; or carrier aggregation (CA) reconfiguration; or re-configuring a group of SCells; or a cell state transition. In some embodiments, wherein the request includes assistance information, a feature of the communication device associated with the first signal, or any one or more of the following information: one or more sparser or denser transmission occasions of the first signal; or a transmission occasion configuration associated with parameters that include: a number of the first signals during a duration or a period, an offset, the duration, and/or a time gap or a specific window for the first signal; a second resource configuration for the first signal including a measurement window or a timer; or a sparser system information block (SIB) transmission or a denser SIB transmission; or a SIB type; or a modification period for an updated system information (SI) message; or a group of SIB transmission. In some embodiments, the first signal includes at least one of the followings: a SSB; or a PSS; or a SSS; or a TRS; or a CSI-RS; or a PDSCH carrying SIB; or CORESET0.

In some embodiments, a next action is performed by the communication device after a time delay after the receiving the indication information. In some embodiments, the next action includes the receiving the first signal, or performing a measurement related to the first signal, or reporting an information related to the measurement related to the first signal. In some embodiments, the reporting is triggered by an event, wherein the event is associated with a cell state transition, a hybrid automatic request-acknowledgement (HARQ-ACK) feedback information, a beam failure recovery, or a asynchronization. In some embodiments, the indication information for the first signal is applicable to a secondary cell (SCell), or a primary cell (PCell), or both the SCell and the PCell. In some embodiments, in response to at least a part of the at least one resource of the first signal being overlapped with PDCCH or PDSCH, the communication device determines not to transmit in an overlapped region where the at least one resource of the first signal is overlapped with the PDCCH or the PDSCH.

In some embodiments, the PDCCH is scrambled by C-RNTI, or CS-RNTI, or MCS-C-RNTI; or the PDSCH is scheduled by a PDCCH scrambled by C-RNTI, or CS-RNTI, or MCS-C-RNTI. In some embodiments, the first signal is received in a measurement window, and wherein the measurement window only includes the first signal.

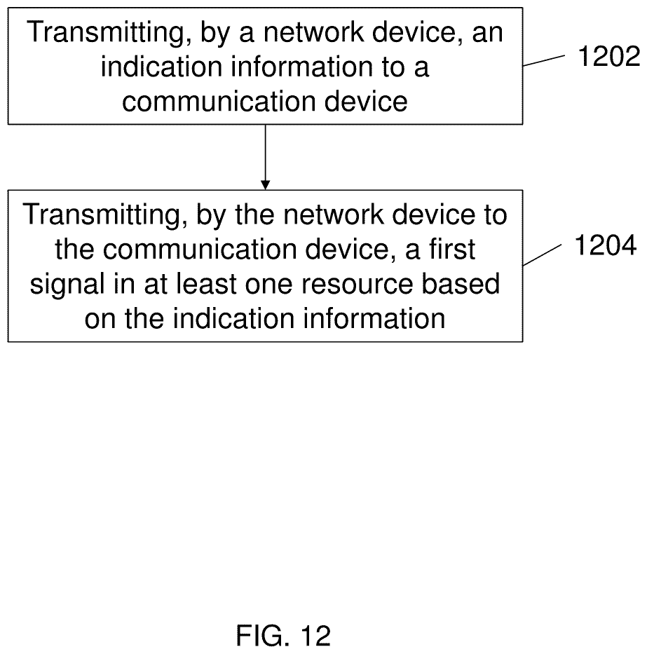

FIG. 12 shows an exemplary flowchart for transmitting a signal based on an indication information. Operation 1202 includes transmitting, by a network device, an indication information to a communication device. Operation 1204 includes transmitting, by the network device to the communication device, a first signal in at least one resource based on the indication information.

In some embodiments, the indication information includes a first resource configuration for the first signal. In some embodiments, a first resource configuration for the first signal includes any one or more of the following: one or more sparser or denser transmission occasions of the first signal; or a transmission occasion configuration associated with parameters that include: a number of the first signals during a duration or a period, an offset, the duration, and/or a time gap or a specific window for the first signal. In some embodiments, the first signal is not transmitted during the time gap, and a length of the time gap is associated with: a time length of a discontinuous transmission (DTX) inactive time, a duration of a carrier that is deactivated, a duration of a cell in an off state, a duration of a secondary cell (SCell) in a dormant state.

In some embodiments, the indication information includes a second resource configuration for the communication device to receive the first signal. In some embodiments, the second resource configuration for the first signal includes a measurement window or a timer. In some embodiments, the measurement window is one of a set of candidate measurement window that is configured by a downlink control information (DCI) signaling or a medium access control-control element (MAC CE) signaling transmitted by the network device, and the measurement window configuration includes any one or more of the followings: a time length of the measurement window, information related to one or more transmission occasions, or one or more start positions of the one or more transmission occasions in the measurement window, a beam direction or a quasi co-location (QCL) relations of the first signal. In some embodiments, the indication is triggered by an event, and wherein the event is associated with a cell state transition. In some embodiments, the cell state transition includes transitioning from or to a state, the state is from a plurality of states that include an activated state, a deactivated state, a dormant state, a state performing DTX, a power saving state, or a low power sate. In some embodiments, the network device performs any one or more of the following on the cell or primary cell (PCell) or the secondary cell (SCell) in response to the cell state transition to the dormant state: determining not to receive a sounding reference signal (SRS); determining not to receive on physical uplink shared channel (PUSCH); or determining not to receive or transmit on a random access channel (RACH); or determining not to transmit on a physical downlink control channel (PDCCH); or determining not to transmit on a physical downlink shared channel (PDSCH); or determining not to receive on a physical uplink control channel (PUCCH); or receiving channel quality indicator (CQI), a precoding matrix indicator (PMI), a rank indicator (RI), a procedure transaction identity (PTI), a channel state information reference signal resource indicator (CRI) for the cell or PCell or SCell; or performing transmissions on the PDCCH or the PDSCH only, or perform CSI-RS transmission only; or performing receptions on the PUCCH or the PUSCH only, or perform SRS reception only; or operating with only a downlink component carrier (DL CC) or only an uplink component carrier (UL CC); or performing the same operations with a cell in off state.

In some embodiments, the indication information includes a sparser system information block (SIB) transmission or a denser SIB transmission; or a SIB type; or a modification period for an updated system information (SI) message; or a group of SIB transmission. In some embodiments, the indication information is a resource set among a list of candidate resource sets for the first signal. In some embodiments, the indication information is included in a downlink control information (DCI) or a medium access control-control element (MAC CE) or a radio resource control (RRC) signaling transmitted by the network device.

In some embodiments, the method further comprises receiving, by the network device, a request for the first signal from the communication device. In some embodiments, the request is received in response to any one or more of the following events being met: transmitting a MAC CE or a DCI which indicates a first signal based measurement; out of sync; or beam failure recovery; or random access failure; or CA reconfiguration; or re-configuring a group of SCells; or a cell state transition. In some embodiments, the first signal includes at least one of the followings: a SSB; or a PSS; or a SSS; or a TRS; or a CSI-RS; or a PDSCH carrying SIB; or CORESET0. In some embodiments, the indication information for the first signal is transmitted in a secondary cell (SCell), or a primary cell (PCell), or both the SCell and the PCell. In some embodiments, the first signal is transmitted in a measurement window, and wherein the measurement window only includes the first signal.

As used herein, including in the claims, “or” as used in a list of items (e.g., a list of items prefaced by a phrase such as “at least one of” or “one or more of”) indicates an inclusive list such that, for example, a list of at least one of A, B or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In this patent document, the base station (BS) may mean that a communication node, or BTS (Base Transceiver Station) in 2G, or NodeB in 3G, or eNB (E-UTRAN NodeB/enhanced NodeB) in 4G, or gNB in 5G, or a base station of LTE (Long term evolution) or NR (New Radio access technology), or a base station of further generation communication system, or a cell with a normal state or activated state or deactivated state or dormant state, or a cell providing basic coverage, or a cell boosting capacity, or a small cell, or a primary cell, or a secondary cell.

In this patent document, a first signal, which is transmitted by BS, may consist of primary synchronization signal (PSS), secondary synchronization signal (SSS) or physical broadcast channel (PBCH) with associated demodulation reference signal (DM-RS) and may also include CORESET for PDCCH scheduling PDSCH with SIB1, and PDSCH carrying SIB1 and/or non-zero power CSI reference signals (CSI-RS), or tracking reference signal (TRS), or may mean a SSB in 5G NR, or an enhanced SSB based on the SSB in 5G NR. Moreover, a first signal can stand for one or more signals or bursts during a duration.

In this patent document, a higher layer parameter may mean that a DCI, a layer 1 (L1) signaling, or a MAC CE, or a layer 2 (L2) signaling, or a RRC signaling, or a layer 3 (L3) signaling.

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer-or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations. enhancements and variations can be made based on what is described and illustrated in this disclosure.

1. A wireless communication method, comprising:
receiving, by a communication device, an indication information that includes a first resource configuration for a first signal,
wherein the indication is triggered by an event that is associated with a cell state transition,
wherein the cell state transition includes transitioning from or to a state,
wherein the state is a state performing discontinuous transmission (DTX), a power saving state, or a low power state; and
receiving, by the communication device, the first signal in at least one resource based on the indication information.

2. The method of claim 1,
wherein the first resource configuration for the first signal includes an offset,
wherein the first signal is not received during a time gap, and
wherein a length of the time gap is associated with a time length of a discontinuous transmission (DTX) inactive time.

3. The method of claim 1,
wherein the indication information includes a second resource configuration to receive the first signal, and
wherein the second resource configuration for the first signal includes a timer.

4. The method of claim 1, wherein a start position of a time gap is associated with a start of a discontinuous transmission (DTX) inactive time, or is associated with a start position or an end position of DTX.

5. The method of claim 1, wherein a next action is performed by the communication device after a time delay after the receiving the indication information.

6. The method of claim 1,
wherein the first signal is not received during a discontinuous transmission (DTX) inactive time, and
wherein the first signal includes a physical downlink control channel (PDCCH), a physical downlink shared channel (PDSCH), or a channel state information reference signal (CSI-RS).

7. The method of claim 2, wherein the first signal includes a physical downlink control channel (PDCCH) or a physical downlink shared channel (PDSCH) that are not transmitted by a network device during the time gap, wherein a length of the time gap is associated with a time length of a discontinuous transmission (DTX) inactive time.

8. A wireless communication method, comprising:
transmitting, by a network device, an indication information to a communication device,
wherein the indication information includes a first resource configuration for a first signal,
wherein the indication is triggered by an event that is associated with a cell state transition,
wherein the cell state transition includes transitioning from or to a state,
wherein the state is a state performing discontinuous transmission (DTX), a power saving state, or a low power state; and
transmitting, by the network device to the communication device, the first signal in at least one resource based on the indication information.

9. The method of claim 8,
wherein the first resource configuration for the first signal includes an offset,
wherein the first signal is not transmitted during a time gap, and
wherein a length of the time gap is associated with a time length of a discontinuous transmission (DTX) inactive time.

10. The method of claim 8,
wherein the indication information includes a second resource configuration for the communication device to receive the first signal, and
wherein the second resource configuration for the first signal includes a timer.

11. The method of claim 8, wherein a start position of a time gap is associated with a start of a discontinuous transmission (DTX) inactive time, or is associated with a start position or an end position of DTX.

12. The method of claim 8,
wherein the first signal is not transmitted during a discontinuous transmission (DTX) inactive time, and
wherein the first signal includes a physical downlink control channel (PDCCH), a physical downlink shared channel (PDSCH), or a channel state information reference signal (CSI-RS).

13. The method of claim 9, wherein the first signal includes a physical downlink control channel (PDCCH) or a physical downlink shared channel (PDSCH) that are not transmitted by the network device during the time gap, wherein a length of the time gap is associated with a time length of a discontinuous transmission (DTX) inactive time.

14. An apparatus for wireless communication comprising a processor that when configured implements a method that causes the apparatus to:
receive, by a communication device, an indication information that includes a first resource configuration for a first signal,
wherein the indication is triggered by an event that is associated with a cell state transition,
wherein the cell state transition includes transitioning from or to a state,
wherein the state is a state performing discontinuous transmission (DTX), a power saving state, or a low power state; and
receive, by the communication device, the first signal in at least one resource based on the indication information.

15. The apparatus of claim 14,
wherein the first resource configuration for the first signal includes an offset,
wherein the first signal is not received during a time gap, and
wherein a length of the time gap is associated with a time length of a discontinuous transmission (DTX) inactive time.

16. The apparatus of claim 14,
wherein the indication information includes a second resource configuration to receive the first signal, and
wherein the second resource configuration for the first signal includes a timer.

17. The apparatus of claim 14, wherein a start position of a time gap is associated with a start of a discontinuous transmission (DTX) inactive time, or is associated with a start position or an end position of DTX.

18. An apparatus for wireless communication comprising a processor that when configured implements a method that causes the apparatus to:
transmit, by a network device, an indication information to a communication device,
wherein the indication information includes a first resource configuration for a first signal,
wherein the indication is triggered by an event that is associated with a cell state transition,
wherein the cell state transition includes transitioning from or to a state,
wherein the state is a state performing discontinuous transmission (DTX), a power saving state, or a low power state; and
transmit, by the network device to the communication device, the first signal in at least one resource based on the indication information.

19. The apparatus of claim 18,
wherein the first resource configuration for the first signal includes an offset,
wherein the first signal is not transmitted during a time gap, and
wherein a length of the time gap is associated with a time length of a discontinuous transmission (DTX) inactive time.

20. The apparatus of claim 18,
wherein the indication information includes a second resource configuration for the communication device to receive the first signal, and
wherein the second resource configuration for the first signal includes a timer.
